(19) United States
(12) Patent Application Publication
(10) Pub. No.: US 2026/0253132 A1
(43) Pub. Date: Aug. 27, 2026

(54) Dynamic Virtual Agent

(71) Applicant: VM Consolidated, Inc., Mesa, AZ (US)

(72) Inventors: Cathi Chinn, Phoenix, AZ (US); Nicola Woodward, Flagstaff, AZ (US)

(21) Appl. No.: 19/063,561

(22) Filed: Feb. 26, 2025

(51) Int. Cl. G06Q 30/0645

(52) U.S. Cl. CPC G06Q 30/0645

(57) ABSTRACT

A system, method, and apparatus are provided for dynamically managing vehicle enrollment by a vehicle with one or more vehicle services by transmitting a service enrollment status request message to a backend server of a vehicle enrollment management server (VEMS) upon detecting that the vehicle is located in a geofence proximity area associated with a vehicle service company, and then receiving a vehicle service enrollment status message which indicates that the vehicle is not enrolled with one or more rental vehicle services and displaying a service enrollment notification message which invites an operator of the vehicle to enroll the vehicle with one or more vehicle services provided by the vehicle service company in response to receiving the vehicle service enrollment status message.

### BACKGROUND OF THE INVENTION

### Field of the Invention

The present disclosure is directed in general to the field of dynamic vehicle service enrollment to provide customer-selected vehicle services. In one aspect, the present disclosure relates to a dynamic service enrollment apparatus, system and method of operation which may be used with rental car customers.

### Description of the Related Art

Traditional car-rental business processes have used human attendants at a check-out counter or during check-out and check-in of rental cars to complete the vehicle rental agreement and otherwise perform simple tasks relating to vehicle check-in and return. More recently, a trend in the industry is to use new technologies to simplify the vehicle rental process. For example, automated kiosks are being used by rental companies that allow customers to complete rental agreements without the need for an employee on location. In addition, consumers are now able to perform more and more transactions using their cell or smart phones. The customer experience is optimized by processes and technology that allow customers to bypass the rental car counter and go directly to the vehicle to save time.

Unfortunately, once a rental car has been checked out to leave the car rental facility, the car rental companies have no available system or process for efficiently and safely enrolling customers with add-on rental car services that the vehicle operator may wish to purchase. For example, there are E-ZPass vehicle toll payment systems which a vehicle operator can access using the operator's cell phone, but such payment systems have relatively complex application processes which discourage individuals from using their phones to access such systems. And by virtue of providing an automated vehicle rental check-out process, there is missed opportunity for rental car company sales of such optional programs and services that were traditionally promoted and sold by rental car company agents, resulting in smaller revenue for car rental companies.

As seen from the foregoing, the existing solutions for quickly and efficiently enrolling a vehicle operator with vehicle-related services are extremely difficult at a practical level by virtue of the challenges with the existing complexity and time requirements for correctly, efficiently, and accurately enrolling a vehicle with customer-specified vehicle services.

### BRIEF DESCRIPTION OF THE DRAWINGS

The present disclosure may be understood, and its numerous objects, features and advantages obtained, when the following detailed description of a preferred embodiment is considered in conjunction with the following drawings.

FIG. 1 is a simplified block diagram of a dynamic virtual service enrollment system for enabling efficient enrollment of rental car services in accordance with selected embodiments of the present disclosure.

FIG. 2 depicts data processing system components of a vehicle and service enrollment management system which are communicatively coupled to initiate and complete service enrollment for a vehicle with a rental car company in accordance with selected embodiments of the present disclosure.

FIG. 3 depicts a simplified flow chart showing the logic for initiating the service enrollment of a vehicle with a rental car management system in accordance with selected embodiments of the present disclosure.

FIG. 4 is a simplified block diagram of a computer data processing system which may be used by a connected vehicle management server, vehicle enrollment management server and/or rental car management server to dynamically provide service enrollment for car rental operators in accordance with selected embodiments of the present disclosure.

### DETAILED DESCRIPTION

A dynamic virtual agent apparatus, system, architecture, methodology, and program code are described for a vehicle service enrollment and management system which enables a vehicle operator to dynamically and efficiently purchase one or more vehicle service (e.g., a return fuel option, an all-inclusive tolling option, an insurance option, or the like) with a vehicle service company. In selected embodiments, a vehicle is configured with an in-vehicle application that communicates over a vehicle network with one or more in-vehicle sensors or databases to detect when the vehicle detects a predetermined triggering event, such as when the vehicle is turned “ON” (or turned “OFF”) or located within (or departing from) a specified vehicle location area (such as a “home location” or rental car terminal proximity). In addition, each vehicle may be connected and configured to communicate with a vehicle enrollment management server/system to provide and receive service enrollment data associated with the vehicle for use in facilitating the purchase of one or more vehicle-related services with the vehicle service company. In support of such service enrollment functions, the in-vehicle application may be configured to transmit vehicle location data or submit a vehicle service enrollment query, to efficiently display a service enrollment application message received from the vehicle enrollment management server/system if the vehicle was not previously enrolled with one or more vehicle service offerings provided by the vehicle service company, and to facilitate an efficient service enrollment of the vehicle with the vehicle service company, such as by providing and displaying a single-click option to the vehicle operator to enroll the vehicle with one or more vehicle service offerings from the vehicle service company. If the vehicle operator signals that they wish to enroll with any vehicle service offering, the in-vehicle application sends a message to the vehicle enrollment management server/system that includes at least a unique identifier for the vehicle, and may include additional information, such as the registered owner's name, license plate number, and a digital wallet identifier for automated billing associated with vehicle service offering purchased by the vehicle driver.

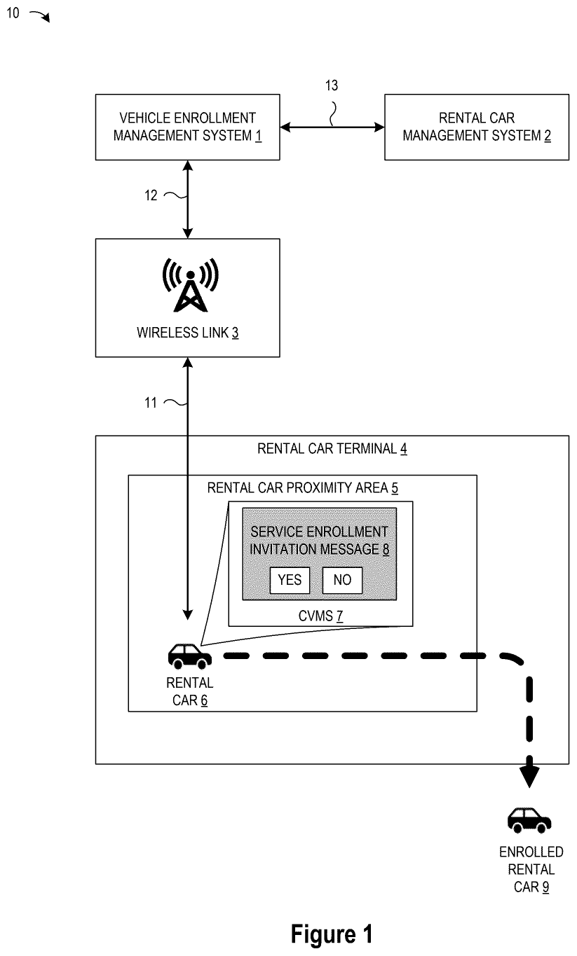

To provide additional details for an improved understanding of selected embodiments of the present disclosure, reference is now made to FIG. 1 which depicts a simplified block diagram of a dynamic virtual service enrollment system 10 for enabling efficient enrollment of rental car services. Generally speaking, the dynamic virtual service enrollment system 10 includes a vehicle enrollment management server/system 1 connected to communicate 13 with a rental car management server system 2. In addition, the vehicle enrollment management server/system 1 is connected over one or more wireless links 3 to communicate 11, 12 with a rental car 6 located in a rental car proximity area 5 of a rental car terminal 4.

In selected embodiments, the vehicle enrollment management server/system 1 may be implemented as a cloud-based system which is communicatively coupled to facilitate service enrollment messages 11-13 exchanged between the rental car management server system 2 and the rental car 6. In addition, the rental car proximity area 5 may be implemented with a geofence which is a virtual fence or perimeter that is positioned around a physical location that is a region of interest (e.g., parking proximity area at a rental car terminal where rental vehicles are parked). Similar to a real fence, a geofence virtually delineates the location or region of interest from the area surrounding it, and can have any shape, including having one or more polygons that are virtually superimposed on a map or area. In addition, movement within the virtual boundary of a geofence can be detected by vehicle sensors in combination with defined polygons of the virtual boundary.

To facilitate efficient service enrollment, the rental car 6 may include a connected vehicle management system (CVMS) 7 which is a computer-based system that uses a vehicle network to gather and manage data from the rental car 6 in real-time, allowing for monitoring, analysis, and control of various aspects (e.g., location, performance, diagnostics, driver behavior, etc.) typically accessed via wireless internet connectivity to a centralized platform to effectively bring the rental car 6 online to facilitate efficient fleet operations and enhance safety features. In accordance with embodiments of the present disclosure and as described more fully hereinbelow, the CVMS 7 may be configured to detect the location and/or movement of the rental car 6 in relation to the rental car proximity area 5 and to display a service enrollment invitation message 8 which prompts the driver of the rental car 6 with a simple “yes” or “no” option to see if they want to enroll in a vehicle service that the rental car company offers. Examples of offered vehicle services include, but are not limited to, a return fuel option, an all-inclusive tolling payment option, a geographically-specified tolling payment option, an insurance option, a loss damage waiver (LDW) coverage option, a collision damage waiver (CDW) coverage option, a theft protection coverage option, an extended roadside assistance option, a satellite radio option, a hand-free navigation option, or the like. In accordance with selected embodiments of the present disclosure, one or more offered vehicle services may be presented by the service enrollment invitation message 8 as an ancillary bundle and/or a derivative bundle of selected fuel, tolling, and liability coverage services.

In operation, the function of the rental car proximity area 5 is to provide a predetermined triggering event to facilitate real-time enrollment of the rental car 6 with one or more ancillary vehicle services. For example, a rental car 6 that is turned “ON” may be configured to retrieve telematics data specifying the location of the rental car 6 and to wirelessly transmit 11, 12 the telematics data to the vehicle enrollment management system 1. Upon detecting that the rental car 6 is parked in the rental car proximity area 5, the vehicle enrollment management system 1 is configured to verify a current service enrollment status of that rental car 6 with the rental car management system 2 and to automatically facilitate the enrollment of the rental car 6 with one or more vehicle services offered by the rental car management system 2. In the event that a vehicle's current service enrollment status query to the vehicle enrollment management system 1 indicates that the rental car 6 is not enrolled with one or more vehicle service offerings, the rental car 6 may be configured to provide an in-vehicle notification, such as a service enrollment invitation message 8, to the vehicle operator providing an opportunity to purchase or enroll in one or more vehicle service offerings. On an affirmative selection by the vehicle operator to enroll in the service(s), the rental car 6 is dynamically registered with the selected vehicle service offering through, for example, an API interface at the CVMS 7 for communicating with the VEMS 1. In other embodiments, the vehicle enrollment management system 1 may be configured to automatically facilitate the enrollment of the rental car 6 with one or more vehicle services upon detecting that the rental car 6 has left the rental car proximity area 5. Once the enrolled rental car 9 leaves the rent car terminal 4, the CVMS 7 may be configured to monitor the activity and actions of the rental vehicle 9 for purposes of tracking the usage of any enrolled vehicle services for use with billing any charges incurred by the rental vehicle 9 while using the enrolled vehicle services.

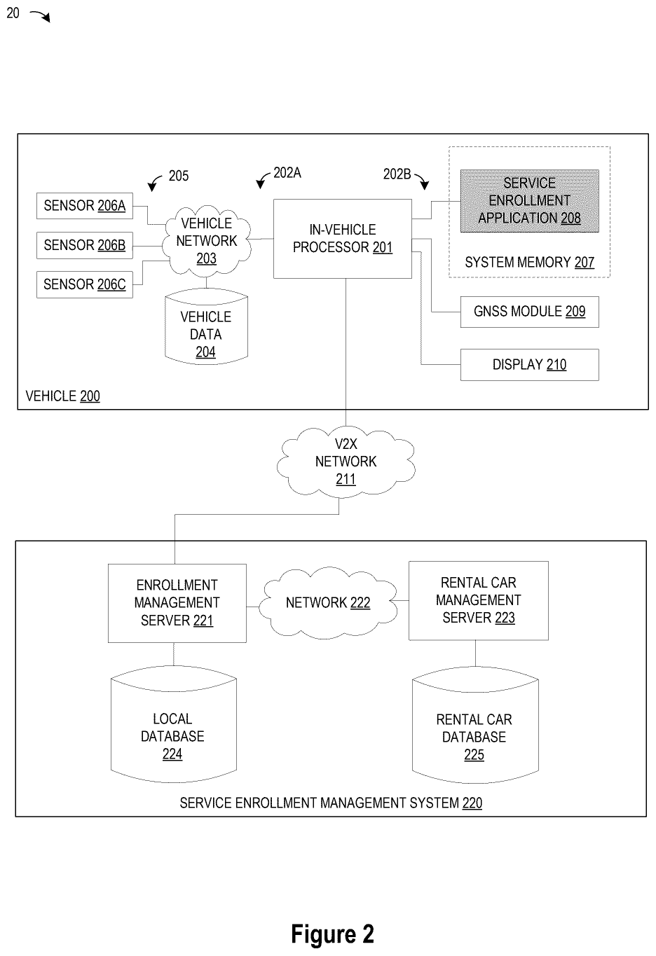

To provide additional details for an improved understanding of selected embodiments of the present disclosure, reference is now made to FIG. 2 which is a diagrammatic depiction 20 of the data processing system components of a vehicle 200 and service enrollment management system 220 which are communicatively coupled over a communication network 211 to initiate and complete service enrollment for a vehicle with a vehicle service company. As disclosed herein, the method and system for dynamically enrolling the vehicle 200 with one or more ancillary vehicle service offerings by the service enrollment management system 220 may be implemented entirely in selected hardware, entirely in software (including firmware, resident software, micro-code, etc.) or in embodiments combining software and hardware aspects that may all generally be referred to herein as a “circuit,” “module” or “system.” Certain implementations may incorporate all, fewer, or greater than the components described herein.

The depicted data processing system components in the vehicle 200 include one or more in-vehicle processor units 201 that are coupled, respectively, over one or more system bus connectors 202A, 202B to a vehicle network 203, system memory 207, a GNSS module 209, and an information display 210, thereby forming an automotive vehicle network. The processor unit(s) 201 can have various architectures, such as a system on a chip (SOC), electronic control unit (ECU), general-purpose processor, multiprocessor, custom compute accelerator, FPGA, hard-wired ASIC, etc. In other embodiments, the vehicle processor unit(s) 201 may be embodied with processor/transceiver that is part of the vehicle (e.g., infotainment system), or a processor/transceiver that is within the vehicle, including but not limited to a mobile phone, dongle, or other processor that is communicatively coupled (e.g., wirelessly or through a wireless an OBDII port) to the vehicle network and/or CAN sensors.

Through the vehicle network 203, the processor unit(s) 201 are coupled over one or more in-vehicle network (IVN) bus connectors 205 to one or more sensors 206A-C and a vehicle data storage device 204. Examples of IVN bus connectors 205 include, but are not limited to, Controller Area Network (CAN) bus, CAN with Flexible Data-Rate (CAN FD) bus, CAN data link layer protocol (CAN XL) bus, Local Interconnect Networks (LIN) bus, FlexRay bus, Ethernet-based network buses, and other types. For example, a CAN bus is a message-based communications bus protocol that is often used within automobiles to enable communications between various electronic control units (ECUs) which perform various control applications, such as for airbags, antilock brakes, cruise control, electric power steering, audio systems, windows, doors, mirror adjustment, battery and recharging systems for hybrid/electric cars, and many more. The CAN bus protocol is used to enable communications between the various bus devices.

As disclosed herein, the sensor(s) 206 may be connected and configured to monitor, track, extract, or collect service-related information which can be used for calculation of the ancillary vehicle service charges for the vehicle. For example, the sensor data may include sensor data collected by a first sensor 206A which detects the geographic location of the vehicle 200 and or which detects when the vehicle 200 is turned “ON.” Additional examples of sensor data include, but are not limited to, sensor data collected by a second sensor 206B which detects data associated with an ancillary return fuel payment service, such as the amount of fuel remaining in the vehicle 200 upon returning the vehicle for rental check-in. In addition or in the alternative, the sensor data may include sensor data collected by a third sensor 206C which detects data associated with an ancillary toll payment service which includes, but is not limited to, sensor data specifying the vehicle location and movements, vehicle occupancy, towing status, fuel type, miles driven, vehicle weight, number of axels, use of high occupancy vehicle lane, and the like. As will be appreciated, the sensor data may also include sensor data that collects data associated with other ancillary vehicle services, including but not limited to, usage of an extended roadside assistance option, a satellite radio option, a hand-free navigation option, or the like.

As disclosed herein, vehicle data storage device 204 may be connected and configured to store predetermined information that is related to any ancillary vehicle services used by the vehicle 200, such as any unique vehicle identification information (e.g., VIN, vehicle operator name, vehicle license plate number, and the like) or other service-related information (e.g., fuel level, toll usage, satellite radio usage, etc.). In addition, the vehicle data storage device 204 may store data identifying one or more rental car proximity corridor geofence areas which are used to evaluate a current location of the vehicle 200 in relation to a rental car terminal. In addition, the vehicle data storage device 204 may store a digital wallet identifier (e.g., Google Pay or Apple Pay or an OEM associated payments system) for automated billing associated with tolls incurred by the vehicle within the corridor geofence.

In accordance with selected embodiments of the present disclosure, the vehicle 200 may also include a vehicle location sensor, such as a global navigation satellite system (GNSS) module 209 (e.g., GPS, Galileo, BeiDou, or QZSS) which includes circuitry to perform geolocation functionality. There might be mapping information in the system memory 207, or that could be part of the in-vehicle service enrollment application 208.

In accordance with selected embodiments of the present disclosure, the vehicle 200 includes a system memory 207 that is populated with data or programming code, including but not limited to operating system (OS) and software programs and any other applications executed by the in-vehicle processor unit(s) 201 for the vehicle 200. In particular, the software programs stored in system memory 207 may include an in-vehicle service enrollment application 208. The in-vehicle service enrollment application 208 can, for example, take the form of embedded software running on an infotainment processor 201 of the vehicle 200 that is coupled to a display 210 viewable by a vehicle operator or another processing device that has access to data from the vehicle sensors 206 or data from the data storage device 204. In addition, the in-vehicle service enrollment application 208 has access to location data generated by the GNSS module 209 to specify a geographic location of the vehicle 200.

In selected embodiments, the in-vehicle service enrollment application 208 may employ one or more sensors 206A-C to detect when the vehicle is turned “ON,” and may employ the GNSS module 209 to detect whether the vehicle is located in a rental car proximity corridor geofence area, to transmit vehicle location data as a vehicle service enrollment status request to the service enrollment management system 220 for purposes of determining if the vehicle is enrolled with one or more ancillary vehicle service offerings, and to receive and process any service enrollment application form or message from the service enrollment management system 220 to efficiently enroll the vehicle with any ancillary vehicle service offerings. In addition, the in-vehicle service enrollment application 208 employs one or more in-vehicle sensors 206 to monitor the activity of the vehicle 200 for purpose of collecting service-related data from the vehicle 200 for use by the service enrollment management system 220 with dynamically tracking and adjusting charges for usage of any enrolled ancillary vehicle service offerings by the vehicle 200.

In selected embodiments, the process for dynamically enrolling the vehicle 200 with ancillary vehicle service offerings by the service enrollment management system 220 may require information that is external to the vehicle 200. To this end, the in-vehicle enrollment application 208 may be connected and configured to communicate over a vehicle-to-everything (V2X) network 211 with the service enrollment management system 220 that has access to a local database 224 storing information identifying any enrolled ancillary vehicle service offerings for the vehicle 200. As will be appreciated, the V2X network 211 may be implemented with other networks, such as a vehicle-to-infrastructure (V2I) network or a vehicle-to-network (V2N) or Vehicle to Connected Vehicle Network (V2CVN). In addition, the service enrollment management system 220 may include an enrollment management services server 221 that communicates not only with the local database 224, but also communicates over network 222 with a rental car management server 223 that stores identification of all enrolled ancillary vehicle services associated with registered vehicle drivers in a rental car database 225.

Once connected over the V2X network 211, in an embodiment in which geographic location is at least part of a trigger for enrollment, the in-vehicle service enrollment application 208 can provide geographic location information to the enrollment management server 221 in order to determine where the vehicle 200 is currently located in relation to any proximity corridor or rental car terminal area. This may be done by comparing the geographic location for the vehicle 200 with rental car proximity area geofences defined at the enrollment management server 221. Alternatively, the rental car proximity area geofences data can be stored in memory accessible to the in-vehicle service enrollment application 208 (e.g., vehicle database 204) and the determination of whether the vehicle is currently located in (or leaving) a rental car proximity area can be made by the in-vehicle service enrollment application 208.

When the vehicle 200 is turned “ON” and located within a rental car proximity area, the in-vehicle service enrollment application 208 can then use the V2X network 211 to transmit telematic location data with a vehicle service enrollment status query to the enrollment management server 221 on whether the vehicle 200 is registered or enrolled with ancillary vehicle service offerings from the rental car company associated with the vehicle. The query submitted by the vehicle 200 may also include a unique identifier for the vehicle that is either pulled from vehicle database 204 (e.g., a VIN) or previously stored by the in-vehicle service enrollment application 208 (e.g., a license plate number). The enrollment management server 221 can use the unique identifier to determine whether the vehicle 200 is enrolled with ancillary vehicle service offerings from the rental car company by performing a lookup on a local database 224. The unique identifier can also be used to perform a reverse lookup for another identifier with which the local database is indexed (e.g., vehicle operator name, vehicle license plate number, and the like). In the event that the enrollment management server 221 does not have the vehicle in the local database 224, the enrollment management server 221 can communicate with a rental car management server 223 to request a search for the vehicle on a rental car database 225. If the rental car company has the vehicle registered for an ancillary vehicle service, the rental car database 225 can use information from the rental car management server 223 to add a registration entry in the local database 224 to the enrollment management server 221.

If the vehicle 200 is not enrolled for an ancillary vehicle service with the rental car company, the enrollment management server 221 will transmit a message to the in-vehicle service enrollment application 208 that the vehicle 200 is not enrolled. In response to that message, the in-vehicle service enrollment application 208 can display a query asking if the vehicle operator would like to enroll one or more ancillary vehicle services for use by the vehicle 200. The in-vehicle service enrollment application 208 can provide the query with a single-click option to the vehicle operator to enroll the vehicle 200 with one or more ancillary vehicle services. Alternatively, the query provide a query interface which allows the operator to individually select from the ancillary vehicle services for enrollment.

If the vehicle operator signals that they wish to enroll the vehicle 200 with one or more ancillary vehicle services, a response message will be sent from the vehicle 200 to the enrollment management server 221 that includes at least a unique identifier for the vehicle, and, if available, the registered owner's name, and a license plate number. If available, a digital wallet identifier (e.g., Google Pay or Apple Pay or an OEM associated payments system) can be provided for automated billing associated with service charges incurred by the vehicle. In selected embodiments, the response message may also include a service enrollment identifier for the one or more ancillary vehicle services being enrolled. As will be appreciated, the service enrollment identifier may be generated by the operator using a single-click option which identifies all of the one or more ancillary vehicle services for automatic enrollment. In other embodiments, the service enrollment identifier may be generated to identify only the operator-selected ancillary vehicle services for automatic enrollment. This stage of query and response within the vehicle 200 is intended to be brief because the vehicle is in motion and the driver's attention should not be distracted from driving. If additional information is required beyond what is available to the in-vehicle service enrollment application 208 at this time, more detailed queries to the vehicle operator will be provided once the vehicle is stopped (e.g., the in-vehicle service enrollment application 208 receives an indication from one or more sensors 206 that the vehicle is parked).

Upon receipt of the vehicle operator response message, the enrollment management server 221 will store the unique identifier and other response message information in an entry in the local database 224. Once the entry is complete, information associated with that entry can be provided to the rental car management server 223 for storage in the rental car database 225.

As will be appreciated, if the exchange of messages confirms that the vehicle 200 is already enrolled with an ancillary vehicle service at the enrollment management server 221 or the rental car management server 223, there is no need for the in-vehicle enrollment steps, and the process will complete with a verification of service enrollment message sent to the in-vehicle service enrollment application 208. Alternatively, should there be some ancillary vehicle services that are available but not yet enrolled for, the process can provide an opportunity to enroll in those not-yet-enrolled for services.

The data processing system components 201-210, 221-225 depicted, respectively, in the vehicle 200 and the service enrollment management system 220 are not intended to be exhaustive, but rather are representative to highlight components that can be implemented by the present disclosure. For instance, the data processing system components may include alternate memory storage devices. In addition, multiple in-vehicle processor devices may be used to run the in-vehicle service enrollment application 208 and a separate vehicle infotainment system. And though not shown, it will be appreciated that the in-vehicle processor unit(s) may be coupled over audio/video adapter modules to input/output devices, including but not limited to one or more display screens or audio input/output devices associated with a vehicle infotainment system. These and other variations are intended to be within the spirit, scope and intent of the present disclosure.

Though described hereinabove with reference to a rental car application wherein vehicle service enrollment is provided for a rental car company, it will be appreciated that the service enrollment application may be used with other types of vehicles, including but not limited to shared vehicles, autonomous vehicles, and the like. In such applications, the triggering event for service enrollment may be adapted to the specific type of vehicle. For example, a “new driver” triggering event for a car share vehicle, such as Zip Car, may occur when the previous “contract” for the car share vehicle is terminated and the vehicle sensors detect that the car share vehicle is first turned “ON” (or “OFF”) or that a passenger or operator has entered the car share vehicle. Alternatively, a triggering event for a car share vehicle may occur when the vehicle is located within a geofence defined area for designated car share parking spaces (e.g., a “home location” area for a Zip Car) and the vehicle is first turned “ON” by the operator. Another triggering event for a car share vehicle may occur when the vehicle operator scans a QR code or through a phone application for the car share vehicle. In another example embodiment for a self-driving autonomous vehicle, such as a Waymo car, a “new passenger” triggering event may occur when the previous “contract” for the autonomous vehicle is terminated and the vehicle sensors detect that a passenger or operator has entered the autonomous vehicle. Alternatively, a triggering event for the autonomous vehicle may be an app-based event, such as when the passenger unlocks the vehicle door with the app to access the autonomous vehicle, or when the passenger hit “start ride” on the app.

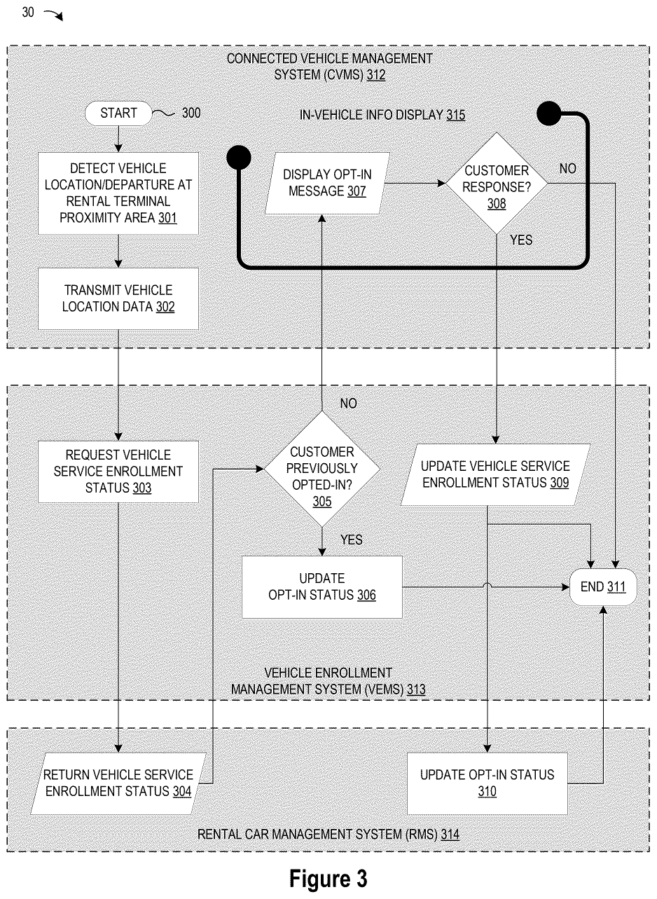

To provide additional details for an improved understanding of selected embodiments of the present disclosure, reference is now made to FIG. 3 which depicts a simplified flow chart 30 showing the logic for initiating the service enrollment of a vehicle with a rental car management system. In an example embodiment, the control logic and methodology shown in FIG. 3 may be implemented in whole or in part with hardware or software on an electronic control unit (ECU), microcontroller unit, or digital system processor that includes processor and memory for storing programming control code for controlling the operation of a vehicle which is communication with a vehicle enrollment management system.

An embodiment of a method for dynamically and efficiently enrolling or registering one or more ancillary vehicle services with a vehicle may include steps 300-311 shown in the general order of FIG. 3, though the method may include more or fewer steps or can arrange the order of the steps differently than those shown. Generally, the method starts with a start operation 300 and ends with step 311 after processing steps 301-310 which are executed as a set of computer-executable instructions by one or more computer systems or processors and encoded or stored in one or more memories which include a computer-readable medium. In other configurations, the method may be executed by a series of components, circuits, and gates created in a hardware device, such as a System of Chip (SOC), Application Specific Integrated Circuit (ASIC), or a Field Programmable Gate Array (FPGA). In other configurations, the method may be executed as an iterative loop where the processing steps 301-310 are periodically repeated on a predetermined schedule or on certain triggering events or when prompted by a vehicle driver.

Once the vehicle starts and is operational at step 300, the connected vehicle management system (CVMS) 312 at the vehicle activates the on-board sensors to collect sensor data reflecting the vehicle operational status, location, and any other required service-related information. As disclosed herein, the disclosed operational steps 300-302, 307-308 performed by the CVMS 312 may be provided by executing suitable program code, such as the service enrollment application 208 depicted in FIG. 2. In selected embodiments, the sensor data signals may be provided by vehicle's on-board sensors 206A-C and GNSS module 209 to the system processor 201 which runs the in-vehicle service enrollment application 208.

At step 301, the vehicle's CVMS 312 detects the vehicle location and/or departure in relation to the rental terminal proximity area. In selected embodiments, the vehicle (e.g., 6), upon being turned “ON,” detects that the vehicle is located in a rental car terminal proximity area (e.g., 5) by using an in-vehicle service enrollment application and location mapping service (e.g., 208) to monitor the location of the vehicle in relation to a rental car geofence area (e.g., 5) associated with a rental car company. Alternatively, a vehicle location system within the vehicle's CVMS 312 may detect the vehicle has departed the rental car geofence area (e.g., 5) at step 301.

At step 302, the vehicle's CVMS 312 transmits vehicle telematic location data to the vehicle enrollment management system (VEMS) 313 which may be implemented as a cloud-based system. In selected embodiments, the CVMS 312 uses an in-vehicle service enrollment application (e.g., 208) to retrieve and transmit vehicle telematics data from the CVMS 312 to the VEMS 313 using a vehicle-to-infrastructure network (e.g., 211) to query the VEMS 313 whether the vehicle (e.g., 200) is enrolled with one or more ancillary vehicle service offerings offered by the rental car company associated with the rental terminal proximity area where the vehicle is located. The query may include a unique identifier for the vehicle that is either pulled from vehicle data storage 204 (e.g., a VIN) or previously stored by the in-vehicle service enrollment application (e.g., a license plate number) 208.

At step 303, the VEMS 313 requests the enrollment or “opt-in” status of the vehicle with respect to one or more ancillary vehicle service offerings offered by the rental car company. In selected embodiments, the VEMS 313 uses the unique identifier to perform a lookup on a local database (e.g., 224) to determine whether the vehicle is registered on the VEMS 313 with any ancillary vehicle service offerings, such as by performing a vehicle lookup operation on a local database (e.g., 224) using the telematic location data and unique identifier from the vehicle's CVMS 312 to request the enrollment status of the vehicle with respect to one or more ancillary vehicle service offerings offered by the rental car company. In other selected embodiments, the VEMS 313 can use the unique identifier to retrieve rental data agreement information from a rental car management system (RMS) 313.

At step 304, the RMS 314 returns the vehicle service enrollment status information to the VEMS 313. In selected embodiments, the vehicle service enrollment status information is returned by the RMS 314 as part of a vehicle enrollment message. To this end, the RMS 314 may use the unique identifier to perform a lookup on a rental car database (e.g., 225) to determine if there is a rental agreement associated with this vehicle and to determine the enrollment status of the vehicle with respect to one or more ancillary vehicle service offerings offered by the rental car company. In selected embodiments, the RMS 314 uses a rental car management system API to determine if there is a rental agreement associated with this vehicle and to determine whether or not the renter has already opted in for an ancillary vehicle service offering.

At step 305, the VEMS 313 determines if the customer has previously enrolled or opted into the ancillary vehicle service offerings. If the customer is already enrolled in the ancillary vehicle service offerings (affirmative outcome to vehicle lookup 305), then there is no need for additional service enrollment steps, and the service enrollment process ends at step 311. At this point, an enrollment status update message may be sent to update the opt-in status information for the customer at step 306.

If the VEMS 313 determines that the customer is not enrolled in one or more of the ancillary vehicle service offerings (negative outcome to vehicle lookup 305), the VEMS 313 may transmit an enrollment request message over the V2X network (e.g., 211) to the vehicle's CVMS 312. In selected embodiments, the enrollment request message may include a message that the VEMS 313 transmits to the in-vehicle service enrollment application (e.g., 208) to indicate that the vehicle 311 is not enrolled with one or more of the ancillary vehicle service offerings.

At step 307, the vehicle's CVMS 312 displays an opt-in message or notification for viewing by the operator of the vehicle which invites the operator to enroll the vehicle with one or more of the ancillary vehicle service offerings from the car rental company. In selected embodiments, the vehicle's CVMS 312 may include an in-vehicle service enrollment application (e.g., 208) which is configured to display a query on an information display 315 inviting the vehicle operator to register or enroll with one or more of the ancillary vehicle service offerings. In selected embodiments, the in-vehicle service enrollment application (e.g., 208) can provide a single-click option to register the vehicle which is displayed on the information display (e.g., 210) for viewing and response by the vehicle operator. As will be appreciated, the ancillary vehicle service offerings for a rental car may be different from the ancillary vehicle service offerings for a car share vehicle or a self-driving autonomous vehicle. For example, a car share vehicle may provide the driver with built-in services for liability insurance coverage, gas, maintenance/roadside assistance and mileage benefits, but if there are limits to the built-in services (e.g., an insurance coverage limit or maximum daily mileage limit), the ancillary vehicle service offerings from a car share service may allow the driver with the option to increase the liability insurance coverage, gas, maintenance/roadside assistance and mileage amounts. Likewise, the passenger for a self-driving autonomous vehicle may be provided with ancillary vehicle service offerings to enhance the passenger experience, such as Wi-Fi connection, satellite radio, toll payment service, etc.

If the vehicle operator declines to enroll in the ancillary vehicle service offerings (negative outcome to detection step 308), then the service enrollment process ends (step 311) and the vehicle will operate without using the ancillary vehicle service offerings. In the event the operator declines enrollment, a message can be sent to the VEMS 313 indicating that the vehicle operator did not wish to register the vehicle. At this time, an entry can also be made to update the vehicle service enrollment status.

However, if the vehicle operator enrolls with one or more of the ancillary vehicle service offerings (affirmative outcome to detection step 308), then the vehicle's CVMS 312 sends a request to the VEMS 313 to enroll the vehicle in the operator-selected ancillary vehicle service offering(s) (step 309). In selected embodiments, the vehicle's CVMS 312 sends a message to the VEMS 313 that includes at least a unique identifier for the vehicle, and, if available, the registered owner's name, and a license plate number. If available, a digital wallet identifier (e.g., Google Pay or Apple Pay or an OEM associated payments system) will be provided for automated billing associated with any enrolled ancillary vehicle services. This stage of query and response between the CVMS 312 and VEMS 312 is intended to be brief because the vehicle is in motion and the driver's attention should be focused on driving the vehicle. If additional information is required beyond what is available to the in-vehicle service enrollment application at this time, more detailed queries to the vehicle operator will be provided once the vehicle is stopped (e.g., the in-vehicle application receives an indication that the vehicle is parked).

After enrolling the vehicle in the operator-selected ancillary vehicle service offering(s) at step 309, the VEMS 313 sends an opt-in update message to the RMS 314. In response, the RMS 314 updates the opt-in status information for the customer at step 310. In selected embodiments, the RMS 314 uses the unique identifier and enrolled service identifiers to update the enrollment status information stored in the rental car database (e.g., 225). After updating the opt-in status for the operator-selected ancillary vehicle service offering(s), the service enrollment process ends (step 311) and the vehicle will operate using the operator-selected ancillary vehicle service offering(s).

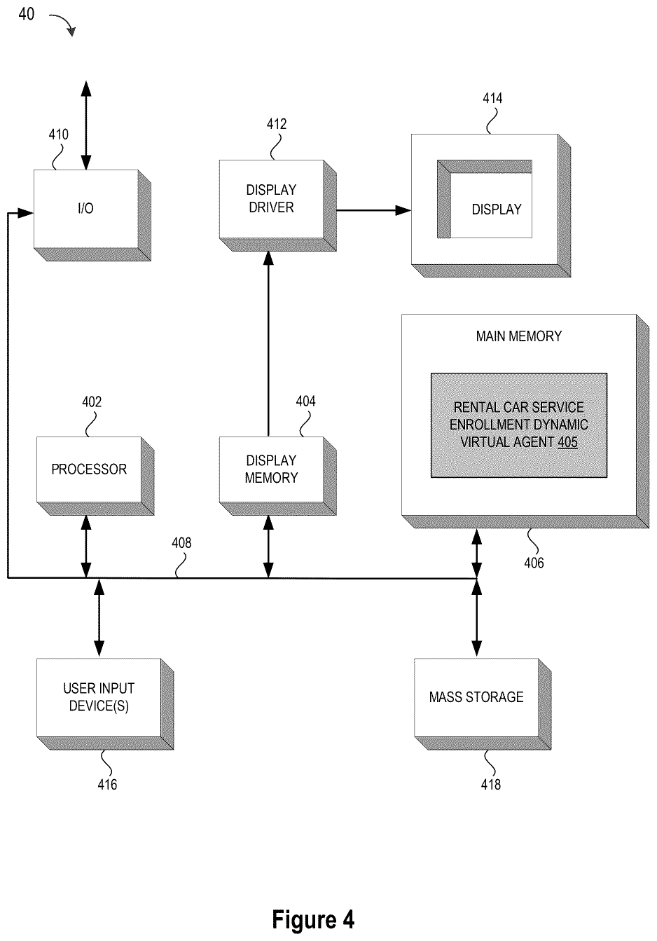

To provide additional details for an improved understanding of selected embodiments of the present disclosure, reference is now made to FIG. 4 which depicts a simplified block diagram of a computer data processing system 40 which may be used by a connected vehicle management server, vehicle enrollment management server and/or rental car management server provide, reserve, allocate, manage, enroll and purchase ancillary vehicle services for use by a vehicle, such as a rental ca. As disclosed, the computer data processing system 40 includes input user device(s) 416, such as a keyboard and/or mouse, which are coupled to a bi-directional system bus 408. The input user device(s) 416 are used for introducing user input to the computer system 40 and communicating that user input to processor 402. The computer system 40 may also include a display memory 404, main memory 406, and mass storage 418, all coupled to bi-directional system bus 408 along with input user device(s) 416 and processor 402. The mass storage 418 may include both fixed and removable media, such as other available mass storage technology. Bus 408 may contain, for example, 32 address lines for addressing display memory 404 or main memory 406. The system bus 408 may also include, for example, an n-bit data bus for transferring data between and among the components, such as CPU 402, main memory 406, display memory 414, and mass storage 418, where “n” is, for example, 32 or 64. Alternatively, multiplex data/address lines may be used instead of separate data and address lines.

The computer system 40 may also include I/O device(s) 410 which provide connections to peripheral devices, such as a printer, and may also provide a direct connection to remote server computer systems via a telephone link or to the Internet via an ISP. I/O device(s) 410 may also include a network interface device to provide a direct connection to remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in mass storage 418 until loaded into main memory 406 for execution. Computer programs may also be in the form of electronic signals modulated in accordance with the computer program and data communication technology when transferred via a network. The method and functions relating to system and method for providing, reserving, allocating, managing, enrolling, and purchasing ancillary vehicle services, such as a return fuel service, a tolling payment service, an insurance service, satellite radio service, hands-free driving service, or the like, may be implemented in a rental car service dynamic virtual agent computer program 405 which uses telematics data from a vehicle to identify rental car service enrollment opportunities from rental data agreement associated with a rental vehicle and to present enrollment opportunities for purchase by the rental vehicle operator.

The processor 402, in one embodiment, is a microprocessor manufactured by Motorola Inc., Intel Corporation, Advanced Micro Devices, or any microprocessor manufacturer. However, any other suitable single or multiple microprocessors or microcomputers may be utilized. Main memory 406 is comprised of dynamic random access memory (DRAM). Display memory 404 is a dual-ported random access memory. One port of the memory 404 is coupled to display amplifier or driver 412. The display amplifier/drive 412 is used to drive the display 414. Display amplifier/drive 412 is well known in the art and may be implemented by any suitable means. This circuitry converts pixel data stored in display memory 404 to a raster signal suitable for use by display 414. Display 414 is a type of monitor suitable for displaying graphic images.

The data processing system components 402, 404, 406, 408, 410, 412, 414, 416, 418 depicted in the computer data processing system 40 are not intended to be exhaustive, but rather are representative to highlight components that can be implemented by the present disclosure. For instance, the data processing system components may include alternate memory storage devices. In addition, multiple processor devices may be used to run the rental car service dynamic virtual agent computer program 405 at either or both of the vehicle computer system(s), enrollment management system(s), and/or rental car management system(s). These and other variations are intended to be within the spirit, scope and intent of the present disclosure.

By now it should be appreciated that there has been provided an apparatus, method, program code, and system for dynamically managing vehicle enrollment by a rental vehicle with one or more rental vehicle services. In the disclosed method, a vehicle processor installed at the rental vehicle detects a predetermined service enrollment triggering event. In selected embodiments, the predetermined service enrollment triggering event may include detecting that the rental vehicle is first turned ON after being rented, detecting that the rental vehicle is first turned OFF after being rented, detecting that the rental vehicle is located in a rental terminal proximity area associated with the car rental company, or detecting that the rental vehicle is leaving a rental terminal proximity area associated with the car rental company. In other selected embodiments, the vehicle processor detects the predetermined service enrollment triggering event by collecting vehicle location data from an in-vehicle global navigation satellite system (GNSS) sensor and comparing the vehicle location data to a virtual geofence map defining the rental terminal proximity area. In addition, the vehicle processor transmits a vehicle service enrollment status request message to a remote vehicle enrollment management server (VEMS) associated with the car rental company in response to said detecting the predetermined service enrollment triggering event. In selected embodiments, the vehicle processor transmits vehicle service enrollment status request message by transmitting connected vehicle management system (CVMS) GPS location data to the VEMS. In addition, the vehicle processor receives a vehicle service enrollment status message from the VEMS which indicates that the rental vehicle is not enrolled with one or more rental vehicle services provided by the car rental company. As disclosed herein, rental vehicle services provided by the car rental company are selected from a group consisting of a return fuel payment service, an all-inclusive tolling payment service, a geographically-specified tolling payment service, an insurance coverage service, a loss damage waiver (LDW) coverage service, a collision damage waiver (CDW) coverage service, a theft protection coverage service, an extended roadside assistance service, a satellite radio service, and a hands-free navigation service for the rental vehicle. In selected embodiments, the vehicle service enrollment status request message and the vehicle service enrollment status message are sent over a wireless connection between the rental vehicle to the VEMS, such as a vehicle-to-everything (V2X) network. In addition, the vehicle processor displays a service enrollment notification message which invites an operator of the rental vehicle to enroll the vehicle with one or more rental vehicle services provided by the car rental company in response to receiving the vehicle service enrollment status message. In selected embodiments, the service enrollment notification message includes a single-click vehicle enrollment option for enrolling the vehicle with the one or more rental vehicle services provided by the car rental company. In addition, the vehicle processor transmits a vehicle service enrollment status update message to automatically enroll the rental vehicle with the one or more rental vehicle services provided by the car rental company. In such embodiments, the vehicle processor may be configured to automatically populate the vehicle service enrollment status update message with a unique identifier for the rental vehicle, alone or in combination with a digital wallet identifier for automated billing associated with enrollment in the one or more rental vehicle services provided by the car rental company.

In another form, there has been provided an apparatus, method, program code, and system for dynamically enrolling a vehicle (e.g., a rental vehicle, a car share vehicle, or a self-driving autonomous vehicle with one or more rental vehicle services provided by a vehicle service company (e.g., a car rental company). In the disclosed method, a backend server of a vehicle enrollment management system (VEMS) receives a vehicle service enrollment status request message which includes data associated with a vehicle located in a predefined geographical area. In selected embodiments, the vehicle detects being located in the predefined geographical area by collecting vehicle location data from an in-vehicle global navigation satellite system (GNSS) sensor and comparing the vehicle location data to a virtual geofence map defining the predefined geographical. In addition, the backend server of the VEMS determines that the vehicle is not registered for one or more vehicle services provided by the vehicle service company. In selected embodiments, the VEMS backend server determines that the vehicle is not registered for one or more vehicle services by using a unique identifier for the vehicle to perform a lookup on a local database to determine whether the vehicle is registered at the VEMS with any ancillary vehicle service offerings. In other selected embodiments, the VEMS backend server determines that the vehicle is not registered for one or more vehicle services by transmitting a unique identifier for the vehicle to the vehicle service company to determine whether the vehicle is registered at the vehicle service company with any ancillary vehicle service offerings. In addition, the backend server of the VEMS transmits a vehicle service enrollment status message which identifies one or more vehicle services provided by the vehicle service company which have not been enrolled by the operator of the vehicle, where the vehicle service enrollment status message causes an application executed by the vehicle to notify the operator of the vehicle that the vehicle is not enrolled with the one or more vehicle services and to invite the operator of the vehicle to enroll the vehicle with the with one or more vehicle services which notifies an operator of the vehicle that the vehicle is not enrolled with one or more vehicle services provided by the vehicle service company and invites the operator of the vehicle to enroll the vehicle with the with one or more vehicle services. In selected embodiments, the vehicle service enrollment status message is displayed for viewing by the operator of the vehicle as a single-click vehicle enrollment option for enrolling the vehicle with the one or more vehicle services provided by the vehicle service company. In addition, the backend server of the VEMS receives a vehicle service enrollment status update message to enroll the vehicle with one or more of the one or more vehicle services provided by the vehicle service company. In addition, the backend server of the VEMS enrolls the vehicle with the VEMS using information contained in the vehicle service enrollment status update message. In selected embodiments, the backend server of the VEMS receives the service enrollment status request message and the vehicle service enrollment status update message over a vehicle-to-everything (V2X) network connecting the vehicle to the backend server of the VEMS. In selected embodiments, the vehicle services provided by the vehicle service company are selected from a group consisting of a return fuel payment service, an all-inclusive tolling payment service, a geographically-specified tolling payment service, an insurance coverage service, a loss damage waiver (LDW) coverage service, a collision damage waiver (CDW) coverage service, a theft protection coverage service, an extended roadside assistance service, a satellite radio service, and a hands-free navigation service for the vehicle.

In yet another form, there has been provided a rental vehicle service enrollment management system, apparatus, method, and program code. The disclosed rental vehicle service enrollment management system includes a rental vehicle having a processor connected over an in-vehicle network to retrieve in-vehicle data from a vehicle data storage and one or more in-vehicle sensors, where the rental vehicle is wirelessly coupled to communicate with a service enrollment management computer that is operable to dynamically enroll the rental vehicle with one or more vehicle services provided by a car rental company. In selected embodiments, the one or more vehicle services provided by the car rental company are selected from a group consisting of a return fuel payment service, an all-inclusive tolling payment service, a geographically-specified tolling payment service, an insurance coverage service, a loss damage waiver (LDW) coverage service, a collision damage waiver (CDW) coverage service, a theft protection coverage service, an extended roadside assistance service, a satellite radio service, and a hands-free navigation service for the rental vehicle. As disclosed, the processor transmits a vehicle service enrollment status request message upon detecting that the rental vehicle is located in or leaving a proximity corridor area associated with the car rental company. In addition, the processor receives, from the service enrollment management computer, a vehicle service enrollment status message after the service enrollment management computer determines that the rental vehicle is not registered with one or more vehicle services provided by the car rental company. In response, the processor is configured to to display a service enrollment notification message at a vehicle display to invite the operator of the rental vehicle to enroll with one or more vehicle services provided by the car rental company with a single-click enrollment option which sends a vehicle service enrollment status update message to automatically enroll the rental vehicle with the one or more vehicle services provided by the car rental company. In selected embodiments, the processor may also be configured to automatically populate the vehicle service enrollment status update message with a unique identifier for the rental vehicle and a digital wallet identifier for automated billing associated with enrollment in the one or more rental vehicle services provided by the car rental company.

Although the described exemplary embodiments disclosed herein focus on a rental vehicle service enrollment management system which can be used with a V2X-enabled vehicle to dynamically and efficiently enroll or register a vehicle with one or more ancillary vehicle services, the present disclosure is not necessarily limited to the example embodiments illustrate herein and may be applied to any vehicle service charging system and/or ancillary vehicle services. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for dynamically managing vehicle enrollment by a rental vehicle with one or more rental vehicle services, comprising:
detecting, by a vehicle processor installed in the rental vehicle, a predetermined service enrollment triggering event;
transmitting, by the vehicle processor, a vehicle service enrollment status request message to a remote vehicle enrollment management server (VEMS) associated with a car rental company in response to detecting the predetermined service enrollment triggering event;
receiving, by the vehicle processor, a vehicle service enrollment status message from the VEMS which indicates that the rental vehicle is not enrolled with one or more rental vehicle services provided by the car rental company; and
displaying, by the vehicle processor, a service enrollment notification message which invites an operator of the rental vehicle to enroll the vehicle with one or more rental vehicle services provided by the car rental company in response to receiving the vehicle service enrollment status message.

2. The method of claim 1, wherein the vehicle service enrollment status request message and the vehicle service enrollment status message are sent over a wireless connection between the rental vehicle to the VEMS.

3. The method of claim 1, where detecting the predetermined service enrollment triggering event comprises detecting that the rental vehicle is first turned ON after being rented, detecting that the rental vehicle is first turned OFF after being rented, detecting that the rental vehicle is located in a rental terminal proximity area associated with the car rental company, or detecting that the rental vehicle is leaving a rental terminal proximity area associated with the car rental company.

4. The method of claim 1, where the one or more rental vehicle services provided by the car rental company are selected from a group consisting of a return fuel payment service, an all-inclusive tolling payment service, a geographically-specified tolling payment service, an insurance coverage service, a loss damage waiver (LDW) coverage service, a collision damage waiver (CDW) coverage service, a theft protection coverage service, an extended roadside assistance service, a satellite radio service, and a hands-free navigation service for the rental vehicle.

5. The method of claim 1, where the service enrollment notification message comprises a single-click service enrollment option for enrolling the rental vehicle with the one or more rental vehicle services provided by the car rental company.

6. The method of claim 1, further comprising transmitting, by the vehicle processor, a vehicle service enrollment status update message to automatically enroll the rental vehicle with the one or more rental vehicle services provided by the car rental company.

7. The method of claim 6, where the vehicle processor automatically populates the vehicle service enrollment status update message with a unique identifier for the rental vehicle.

8. The method of claim 6, where the vehicle processor automatically populates the vehicle service enrollment status update message with a unique identifier for the rental vehicle and a digital wallet identifier for automated billing associated with enrollment in the one or more rental vehicle services provided by the car rental company.

9. The method of claim 1, where transmitting the vehicle service enrollment status request message comprises transmitting connected vehicle management system (CVMS) GPS location data to the VEMS.

10. A method for dynamically enrolling a vehicle with one or more vehicle services, comprising:
receiving, by a backend server of a vehicle enrollment management system (VEMS), a vehicle service enrollment status request message, wherein the vehicle service enrollment status request message comprises data associated with a vehicle located in a predefined geographical area;
determining, by the backend server of the VEMS, that the vehicle is not registered for one or more vehicle services provided by the vehicle service company;
transmitting, by the backend server of the VEMS, a vehicle service enrollment status message which identifies one or more vehicle services provided by the vehicle service company which have not been enrolled by the operator of the vehicle, where the vehicle service enrollment status message causes an application executed by the vehicle to notify the operator of the vehicle that the vehicle is not enrolled with the one or more vehicle services and to invite the operator of the vehicle to enroll the vehicle with the with one or more vehicle services;
receiving, by the backend server of the VEMS, a vehicle service enrollment status update message to enroll the vehicle with one or more of the one or more vehicle services provided by the vehicle service company; and
enrolling, by the backend server of the VEMS, the vehicle with the VEMS using information contained in the vehicle service enrollment status update message.

11. The method of claim 10, wherein the vehicle is a rental vehicle, a car share vehicle, or a self-driving autonomous vehicle.

12. The method of claim 10, wherein the backend server of the VEMS receives the vehicle service enrollment status request message and the vehicle service enrollment status update message over a vehicle-to-everything (V2X) network connecting the vehicle to the backend server of the VEMS.

13. The method of claim 10, wherein the vehicle detects being located in the predefined geographical area by collecting vehicle location data from an in-vehicle global navigation satellite system (GNSS) sensor and comparing the vehicle location data to a virtual geofence map defining the predefined geographical area.

14. The method of claim 10, wherein the one or more vehicle services provided by the vehicle service company are selected from a group consisting of a return fuel payment service, an all-inclusive tolling payment service, a geographically-specified tolling payment service, an insurance coverage service, a loss damage waiver (LDW) coverage service, a collision damage waiver (CDW) coverage service, a theft protection coverage service, an extended roadside assistance service, a satellite radio service, and a hands-free navigation service for the vehicle.

15. The method of claim 10, where determining that the vehicle is not registered for one or more vehicle services comprises using a unique identifier for the vehicle to perform a lookup on a local database to determine whether the vehicle is registered at the VEMS with any ancillary vehicle service offerings.

16. The method of claim 10, where determining that the vehicle is not registered for one or more vehicle services comprises transmitting a unique identifier for the vehicle to the vehicle service company to determine whether the vehicle is registered at the vehicle service company with any ancillary vehicle service offerings.

17. The method of claim 10, where the vehicle service enrollment status message is displayed for viewing by the operator of the vehicle as a single-click vehicle enrollment option for enrolling the vehicle with the one or more vehicle services provided by the vehicle service company.

18. A rental vehicle service enrollment management system, comprising:
a rental vehicle comprising a processor connected over an in-vehicle network to retrieve in-vehicle data from a vehicle data storage and one or more in-vehicle sensors, where the rental vehicle is wirelessly coupled to communicate with a service enrollment management computer that is operable to dynamically enroll the rental vehicle with one or more vehicle services provided by a car rental company,
wherein the processor transmits a vehicle service enrollment status request message upon detecting that the rental vehicle is located in or leaving a proximity corridor area associated with the car rental company;
wherein the processor receives, from the service enrollment management computer, a vehicle service enrollment status message after the service enrollment management computer determines that the rental vehicle is not registered with one or more vehicle services provided by the car rental company; and
wherein the processor is configured to display a service enrollment notification message at a vehicle display to invite the operator of the rental vehicle to enroll with one or more vehicle services provided by the car rental company with a single-click enrollment option which sends a vehicle service enrollment status update message to automatically enroll the rental vehicle with the one or more vehicle services provided by the car rental company.

19. The rental vehicle service enrollment management system of claim 18, where the processor is configured to automatically populate the vehicle service enrollment status update message with a unique identifier for the rental vehicle and a digital wallet identifier for automated billing associated with enrollment in the one or more rental vehicle services provided by the car rental company.

20. The rental vehicle service enrollment management system of claim 18, where the one or more vehicle services provided by the car rental company are selected from a group consisting of a return fuel payment service, an all-inclusive tolling payment service, a geographically-specified tolling payment service, an insurance coverage service, a loss damage waiver (LDW) coverage service, a collision damage waiver (CDW) coverage service, a theft protection coverage service, an extended roadside assistance service, a satellite radio service, and a hands-free navigation service for the rental vehicle.
